(19) United States
(12) Patent Application Publication
(10) Pub. No.: US 2026/0287325 A1
(43) Pub. Date: Sep. 24, 2026

(54) DEVICE FOR MEASURING PITCH ANGLE AND ASSOCIATED METHOD FOR MEASURING PITCH ANGLE

(71) Applicant: SAFRAN AIRCRAFT ENGINES, PARIS (FR)

(72) Inventors: Bastien Pierre VERDIER, MOISSY CRAMAYEL (FR); Jean Charles Olivier RODA, MOISSY CRAMAYEL (FR)

(21) Appl. No.: 18/881,116

(22) PCT Filed: Jul. 3, 2023
(86) PCT No.: PCT/FR2023/051012

§ 371 Date: Jan. 3, 2025

(30) Foreign Application Priority Data
Jul. 5, 2022 (FR) FR2206859

(51) Int. Cl. G01B 7/30; F01D 21/00

(52) U.S. Cl. CPC G01B 7/30; F01D 21/003

(57) ABSTRACT

A device for measuring the pitch angle of blades of a turbine engine with a first axis, includes a movable wheel centred on the first axis and provided with a plurality of blades arranged radially about the first axis, each blade having a root at which it is mounted to pivot about a second radial pivoting axis, a fixed frame of axis, including a set of fixed magnetic sensors perpendicular to the first axis X, the movable wheel including a first magnetic target, the magnetic target being attached to the movable wheel, each blade having a profile oriented along a third axis, a first magnetic needle attached to a first blade and forming a first angle alpha with the third axis of the first blade, the first magnetic target serving as a reference for the first blade, the measuring device including a second magnetic needle attached to a second blade.

### TECHNICAL FIELD OF THE INVENTION

The technical field of the invention is that of variable pitch vanes in turbomachines. The invention finds particular application in the field of aeronautics, especially for the vanes of turbojet engines or turboprops of aeroplanes.

The present invention relates to the measurement of the pitch angle of vanes and in particular to a pitch angle measurement device and a pitch angle measurement method using this device.

### TECHNOLOGICAL BACKGROUND OF THE INVENTION

FIG. 1 represents a turbomachine 1 with a first axis X with, from upstream to downstream, a fan module 2 and a twin spool gas generator formed of a first compressor 3, a second compressor 4, a combustion chamber 5, and two series turbines 6 and 7. The fan module 2 is mounted to a fixed frame 80 with a first axis X and is comprised of a movable wheel 21 centred on the first axis X. During operation of the turbomachine 1, the movable wheel rotates about the first axis X. The movable wheel is provided with a plurality of vanes 22 radially disposed about the first axis X. As illustrated in FIG. 2, each vane 22 includes a root 22a at which it is pivotably mounted about a second, radial pivot, axis Y. Thus, further to rotating about the axis X integrally with the movable wheel 21, each vane 22 pivots about the second, radial pivot, axis Y. This pivoting movement corresponds to a change in the pitch angle of each vane 22. Pivoting is controlled as a function of flight requirements.

The pitch angle of a vane 22 corresponds to the orientation of the vane 22 relative to the axis X of the turbomachine 1. As illustrated in FIG. 3, the first axis X of the turbomachine 1 corresponds to the flow direction of gases circulating in the turbomachine, represented by the arrow F. When vane 22 is in the “flag” position, represented by line Pd, it allows the gases to flow and its pitch angle is 90°, relative to a tangential straight line Δ. When the vane 22 is in the “reverse” position, represented by the line Pr, its pitch is reversed and reverses the flow direction of gases about the vane 22. The pitch angle then lies within an angular range of negative angles from approximately 0 degree to −20 degrees. Between these two positions, the vane is in a so-called flight pitch position Pv. In systems with a variable vane angle, measuring the vane angle makes it possible to control and adjust it accordingly according to flight requirements.

There are devices for pitch angle measurement using needles made of ferromagnetic material coupled to magnetic sensors. An example of this type of solution is illustrated in FIGS. 4 and 5. A magnetic needle 110, attached to the root 22a of a vane 22 whose angle of pitch is measured, passes in front of a fixed sensor 120, which then detects a magnetic field variation. By analysing the signal detected by the fixed sensor 120, it is possible to determine the vane pitch angle by using reference signals corresponding to the detection of an absolute reference target 13 and relative reference targets 14.

However, the angular measurement range of this type of device is often limited to the turbomachine architecture. Indeed, as illustrated in FIG. 6, there is a measurement dead angle θ_{M} due to the physical limits of the detection field of the fixed sensor 120, and restrictions on the length of the magnetic needle 110 imposed by positioning of the other components of the turbomachine. For example, in FIG. 6, the magnetic needle 110 no longer passes into the detection field of the fixed sensor 120 for positions between the positions P_{d} and Pᵥ₀ of the vane 22, corresponding to positions of the magnetic needle 110_{d} and 110ᵥ₀. Typically, the range of pitch angles between 60 and 90 degrees is not measurable.

Generally speaking, with some turbojet architectures, it is impossible to measure the entire angular range covering the pitch angles between the “flag” position and the “reverse” position. However, it is advantageous to measure all the vane pitch positions. For example, when the turbojet engine is started up, vanes are typically in the “flag” position. However, it is possible that this position is not measurable in the case where the position of the corresponding magnetic needle 110 is in a dead angle of the fixed sensor 120.

### SUMMARY OF THE INVENTION

The invention offers a solution to the problems previously discussed, by making it possible to widen the measurement range of pitch angle, in order to improve control of this parameter.

A first aspect of the invention relates to a device for measuring vane pitch angle of a turbomachine with a first axis X, comprising:
a movable wheel centred on the first axis X provided with a plurality of vanes radially disposed about the first axis X, each vane having a root at which it is pivotably mounted about a second, radial pivot, axis Y,
a fixed frame of axis X, comprising at least one set of fixed magnetic sensors perpendicular to the first axis X,
the movable wheel comprising a first magnetic target, the magnetic target being fixed on the moving wheel,
   each vane having a profile oriented along a third axis Z,
a first magnetic needle attached to a first vane and forming a first angle alpha with the third axis of the first vane,
   the first magnetic target serving as a marker for the first vane,
   the measurement device comprising a second magnetic needle attached to a second vane and forming a second angle beta with the third axis of the second vane, the second angle beta being different from the first angle alpha.

By virtue of the invention, the angular range of pitch angle measurement is widened. It is possible to measure pitch angles corresponding to extreme vane pitch positions such as the “flag” position and the “reverse” position, due to the offset between the first magnetic needle and the second magnetic needle.

Advantageously, the second angle beta is between alpha +20 degrees and alpha +50 degrees. Thus, a pitch angle measurement range of up to 110 degrees can be achieved.

Advantageously, the first angle alpha is between 70 degrees and 130 degrees. The value of the first angle alpha depends on the angular range of the pitch angle measurement. Indeed, in the flag position P_{d}, the pitch angle may be equal to 85 or 90 degrees relative to the tangential straight line Δ. In the reverse position Pᵣ, the pitch angle can be −5 degrees or −15 degrees. This range of values makes it possible to arrange the first magnetic needle and the second magnetic needle so that they can pass into the detection field of magnetic sensors.

In a first embodiment, the movable wheel comprises a second magnetic target serving as a marker for the second vane, the first vane and the second vane are successive, and the at least one set of fixed magnetic sensors consists of a single set of magnetic sensors. This configuration reduces the number of needles to be installed on at least some of the turbine vanes.

In a second embodiment, the first vane and the second vane are one and the same and the fixed frame comprises a first set and a second set of fixed magnetic sensors perpendicular to the first axis X. This configuration makes it possible to measure the pitch angle of each turbine vane regardless of the value of the pitch angle within the angular measurement range.

In the second embodiment, the first magnetic needle and the second magnetic needle are of the same length. This configuration makes it possible to enhance redundancy of the measurement system and improve accuracy of the pitch angle measurement.

In one alternative of the second embodiment, the first magnetic needle and the second magnetic needle are of different lengths. This configuration makes it possible to balance redundancy of the measurement system while retaining an extended angular range of pitch angle measurement.

Advantageously, the first magnetic needle and the second magnetic needle have different shapes. This configuration facilitates signal processing by the processing unit.

A second aspect of the invention relates to a method for measuring vane pitch angle of a turbomachine using the measurement device according to the first embodiment, the measurement device further comprising a processing unit, the method comprising:
either a single detection step (E1a), by the single set of magnetic sensors, for detecting a single magnetic field variation,
or a multiple detection step (E1b), by the single set of magnetic sensors, for detecting a first magnetic field variation and a second magnetic field variation, where:
   if the method comprises the single detection step (E1a), the single magnetic field variation corresponds to the passage of the first magnetic needle or the second magnetic needle in proximity to the single row of sensors,
   if the method comprises the multiple detection step (E1b), the first magnetic field variation corresponds to the passage of the first magnetic needle in proximity to the single set of sensors, and the second magnetic field variation corresponds to the passage of the second magnetic needle in proximity to the single set of sensors, and where the method comprises, following the single detection step (E1a) or the multiple detection step (E1b), a step of calculating the pitch angle (E4) by the processing unit on the basis of an electrical signal representative of a magnetic field variation.

A third aspect of the invention relates to a method for measuring vane pitch angle of a turbomachine by a measurement device according to the second embodiment or its alternative, the measurement device further comprising a processing unit, the method comprising:
either a single detection step (E2a), by the first set of magnetic sensors or by the second set of magnetic sensors, for detecting a single magnetic field variation,
or a multiple detection step (E2b) for detecting a first magnetic field variation by the first set of magnetic sensors and a second magnetic field variation by the second set of magnetic sensors,
   where:
   if the method comprises the single detection step (E2a), the single magnetic field variation corresponds to the passage of either the first magnetic needle in proximity to the first set of magnetic sensors or the second magnetic needle in proximity to the second set of sensors,
   if the method comprises the multiple detection step (E2b), the first magnetic field variation corresponds to the passage of the first magnetic needle in proximity to the first set of sensors, and the second magnetic field variation corresponds to the passage of the second magnetic needle in proximity to the second set of sensors,
   and where the method comprises, following the single detection step (E2a) or the multiple detection step (E2b), a step of calculating the pitch angle (E5) by the processing unit on the basis of an electrical signal representative of a magnetic field variation.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a schematic representation of a turbomachine according to prior art.

FIG. 2 shows a vane root of a variable pitch turbomachine according to prior art.

FIG. 3 represents different pitch positions for a turbomachine vane.

FIG. 4 represents a three-dimensional view of a turbomachine vane angle measurement device according to prior art.

FIG. 5 is a transverse cross-section of the turbomachine vane angle measurement device of FIG. 4.

FIG. 6 is an illustration of a measurement dead angle of a turbomachine vane angle measurement device according to prior art.

FIG. 7 represents the direction of a third axis along which each of the turbomachine vanes according to the invention are oriented.

FIG. 8a and FIG. 8b schematically illustrate positioning of a first magnetic needle and a second magnetic needle according to the invention.

FIG. 9a and FIG. 9b represent a device for measuring pitch angle according to one embodiment of the invention.

FIG. 10a, FIG. 10b, FIG. 10c and FIG. 10d represent, for different vane pitch angles, a pitch angle measurement device according to a second embodiment of the invention.

FIG. 11a, FIG. 11b, FIG. 11c and FIG. 11d represent, for different vane pitch angles, a pitch angle measurement device according to one alternative of the second embodiment of the invention.

FIG. 12 schematically represents, for different vane pitch angles, an example of a signal received by a processing unit of the pitch angle measurement device according to the first embodiment of the invention.

FIG. 13 schematically represents, for different vane pitch angles, examples of signals received by the processing unit of the pitch angle measurement device according to the second embodiment of the invention.

FIG. 14 schematically represents, for different vane pitch angles, examples of signals received by the processing unit of the pitch angle measurement device according to the alternative of the second embodiment of the invention.

### DETAILED DESCRIPTION

The figures are set forth by way of indicating and in no way limiting purposes of the invention.

Unless otherwise specified, a same element appearing in different figures has a single reference.

The present invention suggests widening the measurement range of the pitch angle of variable pitch vanes of a turbomachine using a combination of magnetic needles attached to the vanes. As will be described below, this widening will be performed by an angular offset of the magnetic needles.

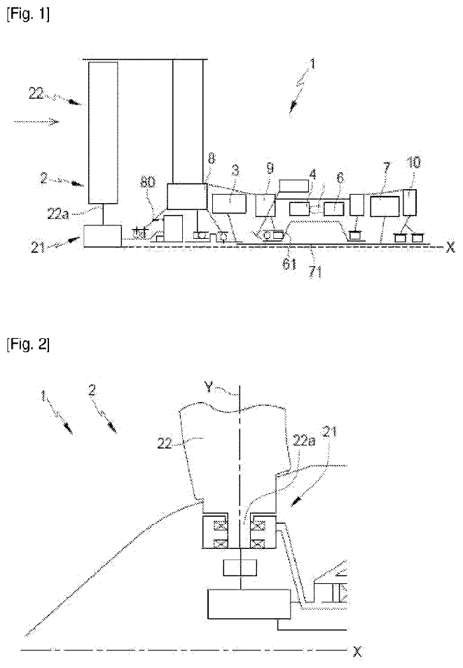

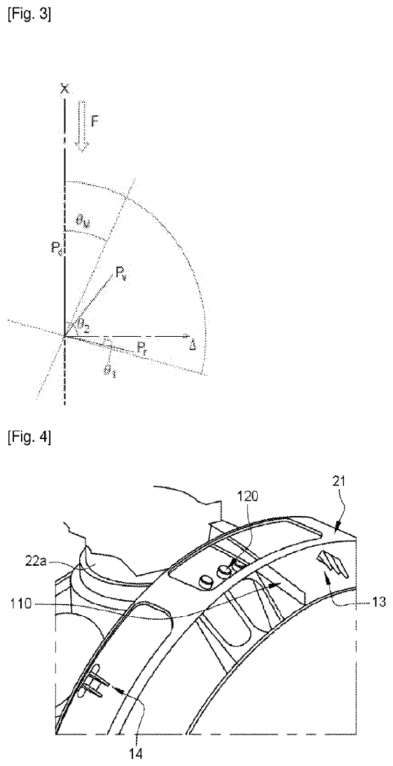

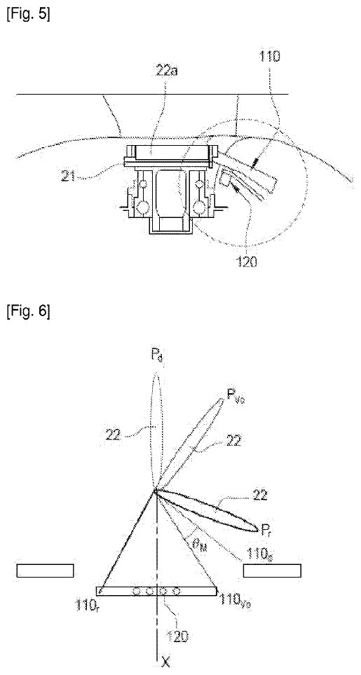

Consider herein a turbomachine 1, of the turbojet type, comprising the components of FIG. 1, and especially the fan module 2 comprising the movable wheel 21 and the vanes 22. The first compressor 3 is connected by a turbine shaft 71 of axis X to the turbine 7 to form a low-pressure spool. The second compressor 4 is connected by a shaft 61, of axis X, to the turbine 6 to form a high-pressure spool. The fixed structural members of the turbomachine comprise an inlet casing 8 located upstream of the gas generator between the fan module 2 and the compressor 3, and the inter-compressor casing 9 between the compressor 3 and the compressor 4. Downstream, force transmission from the engine to the suspension is ensured by an exhaust casing 10. The movable wheel 21 is integral with a rotor of the compressor 3 rotatably mounted in the inlet casing 8.

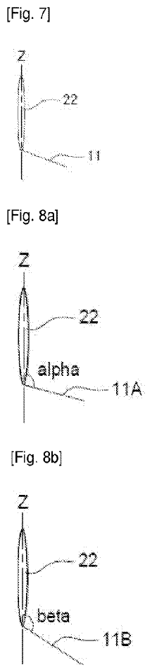

Each vane 22 defines the direction of a third axis Z, as illustrated in FIG. 7.

Magnetic needles 11 are attached at the roots of at least one part of the vanes 22 of the movable wheel 21. In other words, a vane 22 of the movable wheel 21 includes a magnetic needle 11, or two magnetic needles 11, or none at all. There are at least two magnetic needles 11, carried either by a same vane 22 of the movable wheel 21, or by two different vanes. There may be magnetic needles 11 on some vanes 22 of the movable wheel 21 or even on all the vanes 22 of the movable wheel 21. The magnetic needles 11 are divided into a first sub-set comprising at least one magnetic needle 11A, hereinafter called type A needle, and a second sub-set comprising at least one magnetic needle 11B, hereinafter called type B needle.

A processing unit is provided to receive and process electrical signals from the magnetic sensors which will be described below.

Each type A needle 11A forms a first angle alpha with the third axis Z of the vane to the root of which it is attached, as illustrated in FIG. 8a. Each type B needle 11B forms a second angle beta with the third axis Z of the vane to which it is attached, as illustrated in FIG. 8b. The second angle beta is different from the first angle alpha. For example, the first angle alpha has a value of between 70 and 130 degrees. For example, the second angle beta is between alpha+20 degrees and alpha+50 degrees.

The movable wheel 21 comprises a magnetic reference target 13, attached to the movable wheel 21 and serving as an absolute azimuth reference. The magnetic reference target has a typical shape, for example comprising three claws, so as to generate an identifiable magnetic field variation when it passes in front of the magnetic sensors previously mentioned and which will be described below, when the movable wheel 21 rotates about the axis X. The magnetic reference target is especially useful for counting the number of revolutions.

In addition, the movable wheel 21 comprises relative magnetic targets 14, fixed on the movable wheel 21 and serving as relative azimuth markers enabling some vanes 22 of the movable wheel 21 to be identified on the electrical signals received by the processing unit as will be seen later. The relative magnetic targets 14 also have a typical shape, for example comprising two claws, so as to generate an identifiable magnetic field variation when they pass in front of the magnetic sensors previously mentioned, when the movable wheel 21 rotates about the first axis X.

In a first embodiment of the vane angle measurement device according to the invention, illustrated in FIGS. 9a and 9b, the fixed frame 80 comprises a single row of magnetic sensors 12. For example, the row of magnetic sensors comprises 4 magnetic sensors. The row of magnetic sensors 12 is perpendicular to the first axis X.

The magnetic sensors of the row of magnetic sensors 12 all detect a same signal when a magnetic needle 11A, 11B passes into their detection field. This same signal is representative of the magnetic field variation induced by the magnetic needle 11A, 11B passing into the detection field of the row of magnetic sensors 12. Thus, this plurality of magnetic sensors ensures redundancy of the signal received, as well as the reception thereof in the case where, for example, one sensor in the row of magnetic sensors 12 is defective. The signal received by the row of magnetic sensors 12 is transmitted to the processing unit. Typically, the signal is an electrical voltage peak. Preferably, the needles 11A, 11B are identical. This configuration avoids the need for different needle heads.

In this embodiment, a type A needle 11A is attached to the root of at least one vane 22 of the movable wheel 21, and a type B needle 11B is attached to the root 22a of the vane successive to the at least one vane on the movable wheel 21. The vanes carrying type A needles are referred to in this embodiment as type A vanes and the vanes carrying type B needles are referred to as type B vanes.

In FIGS. 9a and 9b, passage of a type A vane and a type B vane into the detection field of the row of magnetic sensors 12 is observed. The pitch angle of the type A vane and the pitch angle of the type B vane are identical. For example, in FIG. 9a, it can be observed that the needle 11A, attached to a first vane, passes at the boundary of the detection field of the row of magnetic sensors 12. Furthermore, as visible in FIG. 9b, due to the offset between the first angle alpha and the second angle beta, the needle 11B attached to a successive vane passes into the detection field of the row of magnetic sensors 12 but no longer at the centre of the detection field compared with FIG. 9a.

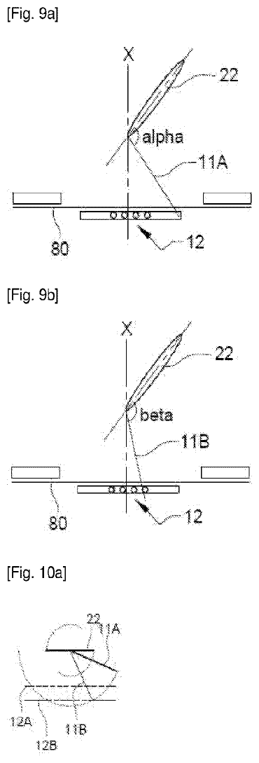

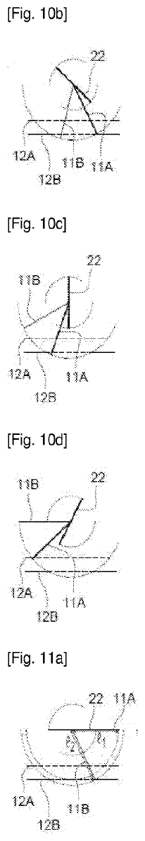

In a second embodiment of the vane angle measurement device according to the invention illustrated in FIGS. 10a, 10b, 10c and 10d, the fixed frame 21 comprises a first row of magnetic sensors 12A and a second row of magnetic sensors 12B distinct from the first row of magnetic sensors 12A. For example, each of the first row of magnetic sensors 12A and the second row of magnetic sensors 12B comprises 4 magnetic sensors.

The first row of magnetic sensors 12A and the second row of magnetic sensors 12B are perpendicular to the first axis X. The first row of magnetic sensors 12A and the second row of magnetic sensors 12B are axially offset along the first axis X. Different vane pitch positions 22 are represented in FIGS. 10a, 10b, 10c and 10d.

Moreover, the processing unit includes a first module and a second module.

The magnetic sensors of the first row of magnetic sensors 12A in FIGS. 10a, 10b, 10c and 10d detect a first signal, identical for each of the sensors, when a magnetic needle 11A, 11B passes into the detection field of the first row of magnetic sensors 12A. Thus, this plurality of magnetic sensors ensures redundancy of the signal received, as well as the reception thereof in the case where, for example, one sensor of the first row of magnetic sensors 12A is defective, or the magnetic needle 11A, 11B is not in the detection field of a sensor. The first signal is representative of the magnetic field variation induced by the magnetic needle 11A, 11B passing into the detection field of the first row of magnetic sensors 12A. The first signal is transmitted and received by the first module of the processing unit. Typically, the first signal is an electrical voltage peak.

The magnetic sensors of the second row of magnetic sensors 12B of FIGS. 10a, 10b, 10c and 10d detect a second signal, identical for each of the sensors, when a magnetic needle 11A, 11B passes into the detection field of the second row of magnetic sensors 12B. Thus, this plurality of magnetic sensors ensures redundancy of the signal received, as well as the reception thereof in the case where, for example, one sensor in the second row of magnetic sensors 12B is defective, or the magnetic needle 11A, 11B is not in the detection field of a sensor. The second signal is representative of the magnetic field variation induced by the magnetic needle 11A, 11B passing into the detection field. The second signal is transmitted and received by the second module of the processing unit. Typically, the second signal is an electrical voltage peak.

In this embodiment, at least one vane 22 of the movable wheel 21 includes a type A needle 11A and a type B needle 11B. The type A needles 11A and the type B needles 11B are of the same length.

In FIG. 10a, only the needle 11B passes into the field of the first row of magnetic sensors 12A and that of the second row of magnetic sensors 12B.

In FIG. 10b, needle 11A and needle 11B both pass into the field of the first row of magnetic sensors 12A and the field of the second row of magnetic sensors 12B.

In FIG. 10c, only the needle 11A passes into the field of the first row of magnetic sensors 12A and that of the second row of magnetic sensors 12B.

In FIG. 10d, only the needle 11A passes into the field of the first row of magnetic sensors 12A.

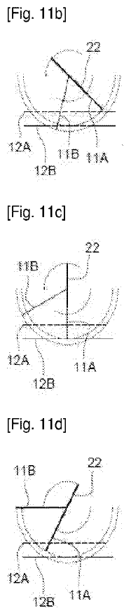

In one alternative to the second embodiment of the vane angle measurement device according to the invention illustrated in FIGS. 11a, 11b, 11c and 11d, a type A needle 11A has a first length 11 and a type B needle 11B has a second length 12 greater than the first length 11. Thus, a type A needle 11A passes only into the detection field of the first row of sensors 12A. Also, a type B needle 11B passes both into the detection field of the first row of sensors 12A and into that of the second row of magnetic sensors 12B. Different vane pitch positions 22 are represented in FIGS. 10a, 10b, 10c and 10d.

In FIG. 11a, only the needle 11B passes into the field of the second row of magnetic sensors 12B.

In FIG. 11b, the needle 11A is not detected. Needle 11B passes both into the detection field of the first row of magnetic sensors 12A and into that of the second row of magnetic sensors 12B.

In FIG. 11c, the needle 11A does not pass into the field of the second row of magnetic sensors 12B, but into that of the first row of magnetic sensors 12A.

In FIG. 11d, only the needle 11A passes into the field of the first row of magnetic sensors 12A.

Thus, the pitch angle measurement device according to the invention enables pitch angles to be measured over a wider angular range than in prior art, typically an angular range of between 100 and 110 degrees, by virtue of the offset between the first angle alpha and the second angle beta. Indeed, this offset makes it possible to define three angular measurement sub-ranges, the extremities of which can reach values corresponding to the extreme pitch positions of the vanes 22, i.e. the “flag” position and the “reverse” position.

A method for measuring vane pitch angle with a variable pitch angle according to the invention will be described hereinafter. When, in flight, a change in the pitch angle of the vanes 22 is actuated, all the vanes 22 are pivoted about their second radial axis Y by the same angle.

In operation, the pitch angle of the vanes 22 of the fan module 2 varies over an angular range [θ₁; θ₂] between the “reverse” position (corresponding to the vane angle θ₁) and the “flag” position (corresponding to the pitch angle θ₂).

The angular range [θ₁; θ₂] is divided into three sub-ranges: a first angular range [θ₁; δ] where only a type A needle 11A is detected; a so-called “multiple range” [δ; γ] where a type A needle 11A and a type B needle 11B are detected; and a second angular range [γ; θ₂] where only a type B needle 11B is detected.

For example, the range [θ1; θ2] is [−20; 90 degrees]. For example, if the first angular range [θ1; δ], is [−20; 30 degrees], the offset between the first angle alpha and the second angle beta can be selected to be equal to 50 degrees. Thus, the second angular range [δ; θ2], is [40; 90 degrees].

The common vane pitch angle is noted φ.

Moreover, it is assumed that the reference magnetic target 13 has a shape with three claws and that the relative magnetic targets 14 have a shape with two claws.

A first embodiment of the method, made by the first embodiment of the vane angle measurement device according to the invention, is described below. Two successive vanes of the movable wheel 21 are respectively a type A vane and a type B vane.

If the common pitch angle o to be measured is included in the first angular range [θ₁; δ], a type A needle 11A is detected by the row of magnetic sensors 12 when the corresponding vane passes in front of the row of magnetic sensors 12.

If the common pitch angle φ to be measured is included in the multiple range [δ; γ], a type A needle 11A and a type B needle are detected by the row of magnetic sensors 12 when the corresponding vanes pass in front of the row of magnetic sensors 12.

If the common pitch angle φ to be measured is included in the second angular range [γ; θ₂], a type B needle 11B is detected by the row of magnetic sensors 12 when the corresponding vane passes in front of the row of magnetic sensors 12.

In operation, the movable wheel 21 rotates about the axis X. The row of magnetic sensors 12 detects, in real time, the reference magnetic target 13, the relative magnetic targets 14, and at least one type A 11A or type B 11B needle which passes into its detection field.

When the magnetic reference target passes into the detection field of the row of magnetic sensors 12, the processing unit receives an absolute reference signal formed by three successive peaks P_{ABS1}, P_{ABS2} and P_{ABS3}, due to the three magnetic field variations successively created by the three claws of the magnetic reference target.

When a relative magnetic target 14 passes into the detection field of the row of magnetic sensors 12, the processing unit receives a relative reference signal formed by two successive peaks P_{REL1} and P_{REL2}, due to the two magnetic field variations successively created by the two claws of said secondary target.

When a current vane 22 comprising a needle 11A, 11B, and in particular its root 22a, passes in front of the row of sensors 12, two configurations are possible, according to the value of the common pitch angle φ.

If the current vane 22 is a type A vane, the processing unit will receive a signal from the row of magnetic sensors 12 only in the case where the type A needle 11A attached to the root of the vane passes into the detection field of the row of magnetic sensors 12. In other words, the processing unit will receive a signal in the case where the common pitch angle φ is included either in the first angular range [θ₁; γ] or in the multiple range [δ; γ]. Otherwise, i.e. if the common pitch angle φ is included in the angular range [γ; θ₂], the processing unit will not receive a signal.

However, the successive vane, i.e. the vane following the current vane 22 on the movable wheel 21, when the latter continues to rotate about the axis X, is a type B vane. Thus, when the successive vane passes, if the common pitch angle φ is included in the angular range [γ; θ₂], the processing unit will receive a signal from the row of magnetic sensors 12 due to the detection of the type B needle 11B in the detection field of the row of magnetic sensors.

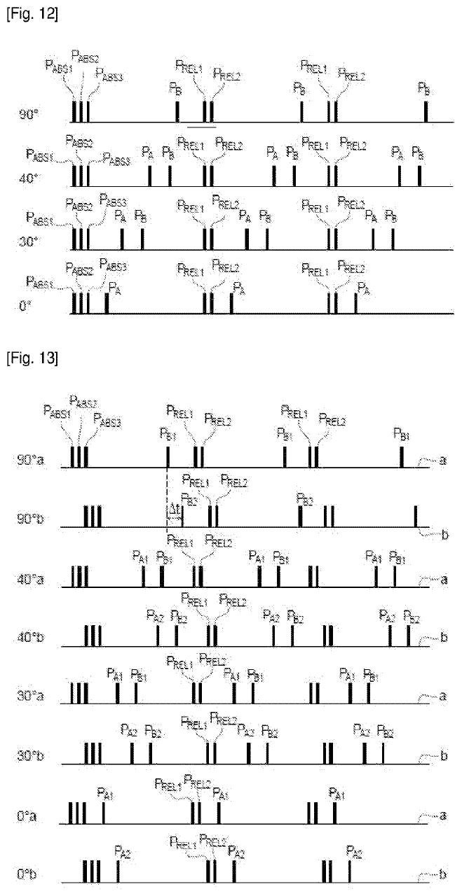

FIG. 12 is a schematic representation of different types of signal received by the processing unit for different values of the common pitch angle φ.

When the common pitch angle φ to be measured is included in the range [γ; θ₂], illustrated by a value equal to 90 degrees, i.e. when the vanes 22 of the movable wheel 21 are in the “flag” position, the processing unit receives, between two relative reference signals, a peak P_{B} corresponding to the passage of a type B needle 11B. The time offset between the relative reference signal formed by peaks P_{REL1} and P_{REL2} and peak P_{B} enables the common pitch angle φ to be calculated from geometric and kinematic parameters of the turbomachine.

The geometric and kinematic parameters of the turbomachine are, for example, the distance from the axis X to the external diameter of the movable wheel 21, corresponding to the support zone for the vane roots 22a, the angle between the reference magnetic target and the secondary target corresponding to the relative reference signal formed by the peaks P_{REL1} and P_{REL2}, the position of the row of magnetic sensors 12 relative to the vane root 22a passing into its field, and the speed of rotation of the movable wheel 21.

When the common pitch angle o to be measured is included in the multiple range [δ; γ], illustrated in FIG. 12 by values equal to 30 or 40 degrees, the processing unit receives, between two secondary reference signals, a first peak P_{A}, and then a second peak P_{B}. The first peak P_{A} corresponds to the passage into the detection field of the row of sensors 12 of a type A vane and the second peak P_{B} corresponds to the passage into the detection field of the row of sensors 12 of the type B vane succeeding the type A vane on the movable wheel 21. The time offset between the first peak and the second peak corresponds to the angular offset between the type A vane and the type B vane following it.

When the common pitch angle φ to be measured is included in the range [θ₁; γ], illustrated in FIG. 12 by a value equal to 0 degree, i.e. when the vanes 22 of the movable wheel 21 are close to the “reverse” position, the processing unit receives, between two relative reference signals, a peak P_{A} corresponding to the passage of a type A needle 11A. The time offset between the relative reference signal formed by the peaks P_{REL1} and P_{REL2} and the peak P_{B} enables the common pitch angle φ to be calculated from geometric and kinematic parameters of the turbomachine 1.

The position of the relative reference signal formed by the peaks P_{REL1} and P_{REL2} makes it possible, by counting from the same absolute reference signal formed by the peaks P_{ABS1}, P_{ABS2} and P_{ABS3} previously received by the processing unit, to identify the vanes 22 of the movable wheel 21 which generated the peaks P_{A} and P_{B}.

A second embodiment of the method, made by the second embodiment of the vane angle measurement device according to the invention, is described below.

At least one vane 22 of the movable wheel 21 includes a type A needle 11A and a type B needle 11B. A type A needle 11A and a type B needle 11B have the same length.

If the common pitch angle φ is included in the first angular range [θ₁; δ], only a type A needle 11A is detected by the first row of magnetic sensors 12A and by the second row of magnetic sensors 12B when the corresponding vane 22 passes into their detection field.

If the common pitch angle φ is included in the multiple range [δ; γ], a type A needle 11A and a type B needle 11B are detected by the first row of magnetic sensors 12A and by the second row of magnetic sensors 12B when the corresponding vanes 22 pass into their detection field.

If the common pitch angle φ is included in the second angular range [γ; θ₂], only one type B needle 11B is detected by the first row of magnetic sensors and by the second row of magnetic sensors 12B when the corresponding vane 22 passes into their detection field.

FIG. 13 is a schematic representation of different types of signals received by the processing unit for different values of the common pitch angle φ.

For each value of the common pitch angle φ illustrated, a first signal a and a second signal b are represented. The first signal a corresponds to the signal received by the first row of magnetic sensors 12A. The second signal b corresponds to the signal received by the second row of magnetic sensors 12B.

When the common pitch angle o to be measured is included in the second angular range [γ; θ₂], illustrated in FIG. 13 by a value equal to 90 degrees, i.e. the vanes of the movable wheel 21 are in the “flag” position, the first module of the processing unit receives the first signal a, which comprises, between two relative reference signals, a primary peak P_{B1} corresponding to the passage of a type B needle 11B. A second module of the processing unit receives the second signal b, which comprises, between two relative reference signals, a secondary peak P_{B2} corresponding to the passage of the needle 11B.

There is a time offset Δt, illustrated in FIG. 13, between the primary peak P_{B1} and the secondary peak P_{B2}. This time offset Δt is due to the fact that the first row of magnetic sensors 12A and the second row of magnetic sensors 12B are axially offset along the axis X. Thus, the distance between the first row of magnetic sensors 12A and the root 22a of the vane 22 passing into its detection field is different from the distance between the second row of magnetic sensors 12B and the root 22a of said vane 22. In other words, the first row of magnetic sensors 12A and the second row of magnetic sensors 12B do not detect at the same time the magnetic field variation induced by the needle 11B passing into their respective detection fields.

The time offset between the relative reference signal formed by the peaks P_{REL1} and P_{REL2} and the primary peak P_{B1} in the first signal a, on the one hand, and that between the relative reference signal formed by the peaks P_{REL1} and P_{REL2} and the secondary peak P_{B2} in the second signal b, make it possible to calculate the common pitch angle φ twice from geometric and kinematic parameters of the turbomachine 1, as in the first embodiment. Thus the accuracy of calculation of the common pitch angle φ is increased.

When the common pitch angle φ to be measured is included in the multiple range [δ; γ], illustrated in FIG. 13 by values equal to 30 or 40 degrees, the first module of the processing unit receives the first signal a. The first signal a comprises, between two relative reference signals, a first primary peak P_{A1}, and then a second primary peak P_{B1}. The first primary peak P_{A1} corresponds to the passage into the detection field of the first row of sensors 12A of the type A needle 11A of the vane 22 facing the first row of sensors 12A. The second primary peak P_{B1} corresponds to the passage into the detection field of the first row of sensors 12A of the type B needle 11B of said vane 22. The time offset between the first peak P_{A1} and the second peak P_{B1} corresponds to the angular offset between the type A needle 11A and the type B needle 11B of the vane 22.

The second module of the processing unit receives the second signal b. The second signal b comprises, between two relative reference signals, a first secondary peak P_{A2}, and then a second secondary peak P_{B2}. The first secondary peak P_{A2} corresponds to the passage into the field of detection of the second row of sensors 12B of the type A needle 11A of the vane 22 when it is facing the second row of sensors 12B. The second secondary peak P_{B2} corresponds to the passage into the detection field of the second row of sensors 12B of the type B needle 11B of said vane. The time offset between the first peak P_{A2} and the second peak P_{B2} corresponds to the angular offset between the type A needle 11A and the type B needle 11B of the vane.

Four measurements of the common pitch angle φ are thus obtained: two measurements from the detection of the magnetic field variation induced by the type A needle 11A of a current vane 22, by the first row of magnetic sensors 12A and the second row of magnetic sensors 12B respectively, and from the detection of the magnetic field variation induced by the type B needle 11B of said current vane 22, by the first row of magnetic sensors 12A and the second row of magnetic sensors 12B respectively. Thus, the accuracy of calculation of the common pitch angle φ is increased.

When the common pitch angle φ to be measured is included in the first angular range [θ₁; γ], illustrated in FIG. 13 by a value equal to 0 degree, i.e. the vanes 22 of the movable wheel 21 are close to the “reverse” position, the first module of the processing unit receives the first signal a. The first signal a comprises, between two relative reference signals, a primary peak P_{A1} corresponding to the passage of a type A needle 11A. The second module of the processing unit receives the second signal b, which comprises, between two relative reference signals, a secondary peak P_{A2} corresponding to the passage of the needle 11A.

The time offset observed in FIG. 13 between the primary peak P_{A1} and the secondary peak P_{A2} is due to the fact that the first row of magnetic sensors 12A and the second row of magnetic sensors 12B are axially offset along the axis X. Thus, the distance between the first row of magnetic sensors 12A and the root 22a of the vane 22 passing into its detection field is different from the distance between the second row of magnetic sensors 12B and the root 22a of said vane 22. In other words, the first row of magnetic sensors 12A and the second row of magnetic sensors 12B do not detect at the same time the magnetic field variation induced by the passage of the needle 11A into their respective detection fields.

The time offset between the relative reference signal formed by the peaks P_{REL1} and P_{REL2} and the primary solid line peak P_{A1} in the first signal a, on the one hand, and between the relative reference signal formed by the peaks P_{REL1} and P_{REL2} and the secondary peak P_{A2} in the second signal b, makes it possible to calculate the common pitch angle φ twice from geometric and kinematic parameters of the turbomachine 1. Thus the accuracy of calculation of the common pitch angle φ is increased.

An alternative to the second embodiment of the method of the invention, made by the alternative to the second embodiment of the device for measuring pitch angle according to the invention, will now be described.

At least one vane 22 of the movable wheel 21 includes a type A needle 11A and a type B needle 11B. In this alternative, a type A needle 11A has a first length l1 and a type B needle has a second length l2 greater than the first length l1, so that a type A needle 11A is only detected by the first row of sensors 12A, and a type B needle 11B is detected by both the first row of magnetic sensors 12A and the second row of magnetic sensors 12B. The opposite configuration, in which a type A needle 11A is only detected by the second row of sensors 12B and a type B needle 11B is detected by both the first row of magnetic sensors 12A and the second row of magnetic sensors 12B, is also possible. The following description will be transposed to this reverse configuration by interchanging the first row of magnetic sensors and the second row of magnetic sensors.

If the common pitch angle φ to be measured is included in the first angular range [θ₁; δ], only one type A needle 11A is detected, and only by the first row of magnetic sensors 12A, when the corresponding vane 22 passes into the detection field of the first row of magnetic sensors 12A.

If the common pitch angle o to be measured is included in the multiple range [δ; γ], a type A needle 11A is detected by the first row of magnetic sensors 12A; a type B needle 11B is detected both by the first row of magnetic sensors 12A and by the second row of magnetic sensors 12B when the corresponding vanes 22 pass into the respective detection fields thereof.

If the common pitch angle φ to be measured is included in a second angular range [γ; θ₂], only a type B needle 11B is detected, and by the first and second rows of magnetic sensors 12A and 12B when the corresponding vane 22 passes into their detection field.

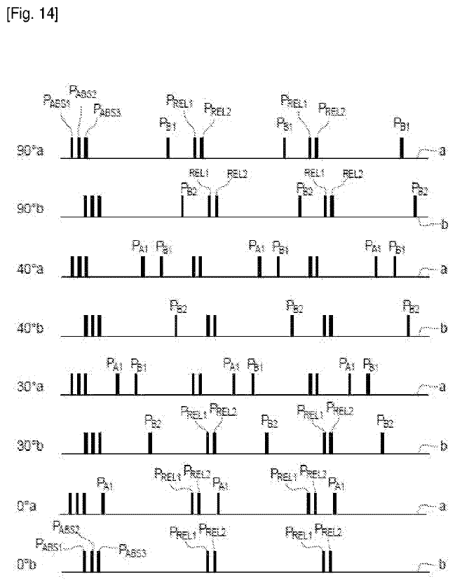

FIG. 14 is a schematic representation of different types of signal received by the processing unit for different values of the common pitch angle φ.

For each value of the common pitch angle φ illustrated, a first signal a and a second signal b are represented. The first signal a corresponds to the signal received by the first row of magnetic sensors 12A. The second signal b corresponds to the signal received by the second row of magnetic sensors 12B.

When the common pitch angle o to be measured is included in the second angular range [γ; θ₂], illustrated in FIG. 14 by a value equal to 90 degrees, i.e. the vanes 22 of the movable wheel 21 are in the “flag” position, the type A needle 11A of a vane 22 comprising a type A needle 11A and a type B needle 11B facing the first row of sensors 12A and the second row of sensors 12B is not detected. But, the type B needle 11B is detected by the first row of sensors 12A. Thus, the first module of the processing unit receives the first signal a, which comprises, between two relative reference signals, a primary peak P_{B1}. The second module of the processing unit receives the second signal b. The second signal b comprises, between two relative reference signals, a secondary peak P_{B2} corresponding to the passage of the type B needle 11B of the vane 22 in the field of the second row of sensors 12B. The time offset, in the first signal a, between the relative reference signal formed by the peaks P_{REL1} and P_{REL2} and the primary peak P_{B1}, and that, in the second signal b, between the relative reference signal formed by the peaks P_{REL1} and P_{REL2} and the secondary peak P_{B2}, enable the common pitch angle φ to be calculated from geometric and kinematic parameters of the turbomachine 1.

When the common pitch angle φ to be measured is included in the multiple range [δ; γ], illustrated in FIG. 14 by values equal to 30 or 40 degrees, the first module of the processing unit receives, between two relative reference signals, a first peak P_{A1}, corresponding to the passage into the detection field of the first row of magnetic sensors 12A of the type A needle 11A of the vane 22 facing the first row of magnetic sensors 12A and the second row of magnetic sensors 12B, and a second peak P_{B1} corresponding to the detection of the type B needle 11B of said vane 22. The second module of the processing unit receives, between two relative reference signals, a single peak P_{B2}, corresponding to the passage of the B-type needle 11B of vane 22 into the detection field of the second row of sensors 12B.

When the common pitch angle φ to be measured is included in the range [θ1; γ], illustrated in FIG. 14 by a value equal to 0 degree, i.e. the vanes 22 of the movable wheel 21 are close to the “reverse” position, the type B needle 11B of the vane 22 facing the first row of sensors 12A and the second row of sensors 12B is not detected. Thus, the second module of the processing unit receives a second signal b solely comprised of the relative reference signals and the absolute reference signal. The first module of the processing unit receives the first signal a. The first signal a comprises, between two relative reference signals, a peak P_{A1} corresponding to the passage of the type A needle of the current vane. The time offset between the relative reference signal formed by the peaks P_{REL1} and P_{REL2} and the peak P_{A1} enables the common pitch angle φ to be calculated from geometric and kinematic parameters of the turbomachine.

This alternative of the measurement method according to the invention enables the common pitch angle φ to be measured over the entire range [θ₁; θ₂] on the basis of clearly identified electrical signals.

Thus, the invention makes it possible to extend measurement range of the pitch angle of the vanes 22 in a variable pitch angle system, by combining magnetic needles. According to the different embodiments of the invention and their alternatives, it is possible, for example, to limit the number of needles, to increase measurement accuracy by multiplying measurements, or to optimise the device according to the invention by limiting its redundancy.

Alternative embodiments of the invention are possible.

Thus, in a first alternative, type A needles 11A have a first shape and type B needles 11B have a second shape different from the first shape. This makes it possible to shape the peaks P_{A1}, P_{A2}, corresponding to the detection of type A needles 11A, and the peaks P_{B1}, P_{B2}, corresponding to the detection of type B needles 11B. This shaping makes it easier to recognise these peaks.

Furthermore, in the different embodiments and alternatives described, it has been described that the detection of type A needles 11A precedes that of type B needles 11B. In other words, type A needles 11A are the first to be detected after a relative reference magnetic target (or the absolute reference magnetic target) has been detected. A second alternative consists of the opposite configuration, i.e. in which the needles 11B of type B are the first detected after the detection of a relative reference magnetic target (or of the absolute reference magnetic target) is possible by modifying geometry of the device.

1. A device for measuring vane pitch angle of a turbomachine with a first axis X, comprising:
a movable wheel centred on the first axis X and provided with a plurality of vanes radially disposed about the axis X, each vane having a root at which the vane is pivotably mounted about a second, radial pivot, axis Y,
a fixed frame of axis X, comprising at least one set of fixed magnetic sensors perpendicular to the first axis X,
the movable wheel comprising a first magnetic target, the first magnetic target being fixed on the movable wheel,
each vane having a profile oriented along a third axis Z,
a first magnetic needle attached to a first vane and forming a first angle alpha with the third axis Z of the first vane,
the first magnetic target serving as a marker for the first vane,
a second magnetic needle attached to a second vane different from the first vane and forming a second angle beta with the third axis Z of the second vane, the second angle beta being different from the first angle alpha.

2. The measurement device according to claim 1, wherein the second angle beta is between alpha +20 degrees and alpha +50 degrees.

3. The device according to claim 1, wherein the first angle alpha is between 70 and 130 degrees.

4. The measurement device according to claim 1, wherein:
the movable wheel comprises a second magnetic target serving as a marker for the second vane,
the first vane and the second vane are successive,
the at least one set of fixed magnetic sensors consists of a single set of magnetic sensors.

5. A method for measuring vane pitch angle of a turbomachine by a measurement device according to claim 4, the measurement device further comprising a processing unit, wherein
the method comprises:
either a single detection step, by the single set of magnetic sensors, for detecting a single magnetic field variation,
or a multiple detection step, by the single set of magnetic sensors, for detecting a first magnetic field variation and a second magnetic field variation,
if the method comprises the single detection step, the single magnetic field variation corresponds to the passage of the first magnetic needle or the second magnetic needle in proximity to the single set of sensors,
if the method comprises the multiple detection step, the first magnetic field variation corresponds to the passage of the first magnetic needle in proximity to the single set of sensors, and the second magnetic field variation corresponds to the passage of the second magnetic needle in proximity to the single set of sensors,
the method comprises, following the single detection step or the multiple detection step, a step of calculating the pitch angle by the processing unit on the basis of an electrical signal representative of a magnetic field variation.
